(19) United States
(12) Patent Application Publication
(10) Pub. No.: US 2011/0261573 A1
(43) Pub. Date: Oct. 27, 2011

(54) SOLAR LIGHT HOLDER

(76) Inventor: CHARLES COX, Castlewood, VA (US)

(21) Appl. No.: 13/091,653

(22) Filed: Apr. 21, 2011

Related U.S. Application Data
(60) Provisional application No. 61/326,383, filed on Apr. 21, 2010.

(51) Int. Cl. F21V 21/096

(52) U.S. Cl. 362/398

(57) ABSTRACT

A magnetic holder for a lamp comprising: a magnetic base, where magnetic base is capable of being mounted onto a metal surface; and a hollow cylindrical device, where the cylindrical device provides a mechanism for insertion of a solar-powered light and the cylindrical device is mounted on the base by an attachment mechanism, where the cylindrical device extends above the top surface of the magnetic base. In one particular embodiment the attachment mechanism may include a bolt and the mechanism for insertion includes a cap. The base of the magnetic holder may mount in either a horizontal or a vertical position.

### CROSS REFERENCE TO OTHER APPLICATIONS

This application claims priority to U.S. Provisional Application Ser. No. 61/326,383 filed on Apr. 21, 2010.

### BACKGROUND OF THE INVENTION

1. Field of Invention

The present invention relates to a magnetic solar light holder used to mount lighting to metal surfaces and particularly adapted for use in outdoor locations.

2. Description of Related Art

Many times in outdoor situations it is necessary to have portable and convenient lighting. Having portable lighting is especially necessary when the individual is camping or travelling with an RV trailer. The available options for portable lighting in such conditions are usually limited to night lanterns or possibly a battery-operated nightlight. Given the need to pursue alternative energy sources the use of solar lighting in these circumstances for would be advantageous. It would also be advantageous to have a light that may be mounted on the surface of the RV or other metal surface so that the light is portable or maneuverable by the user.

### SUMMARY OF THE INVENTION

The present invention relates to a magnetic holder for a lamp comprising: a magnetic base, where magnetic base is capable of being mounted onto a metal surface; and a hollow cylindrical device, where the cylindrical device provides a means for insertion of a solar-powered light and the cylindrical device is mounted on the base by an attachment means, where the cylindrical device extends above the top surface of the magnetic base. In one particular embodiment the attachment means may include a bolt and the means for insertion includes a cap. The base of the magnetic holder may mount in either a horizontal or a vertical position.

### BRIEF DESCRIPTION OF DRAWINGS

FIG. 1 depicts a top view of a solar light holder according to the present invention.

FIG. 2 depicts a side view of the light holder according to the present invention.

FIG. 3 depicts the insertion of a solar lamp into the light holder according to the present invention.

FIG. 4 depicts alternative L-shaped light holders according to the present invention.

### DETAILED DESCRIPTION

The present invention relates to a magnetic light holder used to hold a solar light that is mountable on metal surfaces. The light holder according to present invention may be mounted on a horizontal surface or alternatively on a vertical surface. The magnetic base provides the support and attachment needs for the light holder.

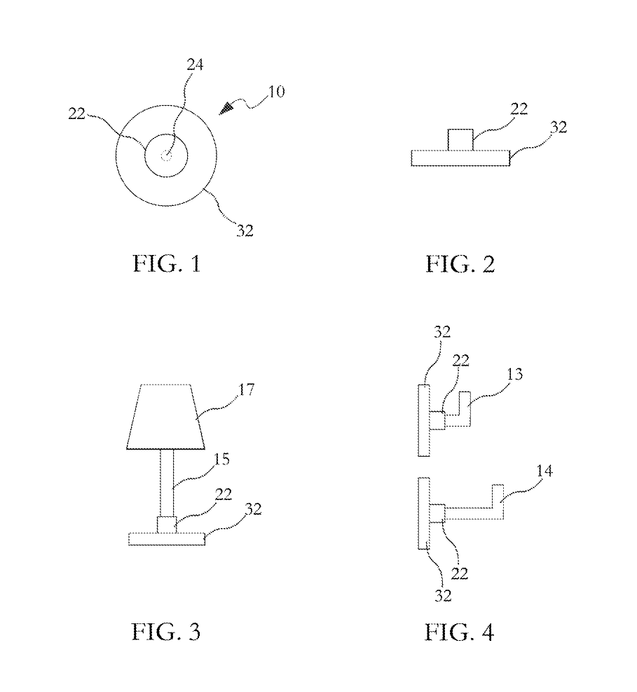

A light holder 10 according to the present invention is depicted in FIG. 1. The light holder 10 includes a magnetic base 32 and a PVC pipe insertion cap 22. The cap 22 is a hollow cylindrical device for the insertion of a solar-powered light. The cap 22 is mounted on the base 32 by using a bolt 24. In one particular embodiment, the base 32, which is shown in a vertical upright position, may be up to one inch thick with the cap 22 extending additional three-quarters of the inch from the top surface of the magnetic base 32. The magnetic base 32 allows the mounting of this light holder onto a metal surface so that the solar lamp may be inserted into the cap 22. An exemplary embodiment of the present invention is depicted in FIG. 3. The cap 22 receives a stem 15 of a solar lamp 17. The stem 15 inserts into the cap 22 and is therefore easily mounted onto the light holder 10. The depiction of the base 32 in a horizontal position shows use of a horizontal application of the present invention.

An alternative embodiment of the present invention is depicted in FIG. 4. The base 32 is rotating for vertical mounting onto a vertical surface. The cap 22 includes an insert 13 or insert 14 that provides a 90-degree elbow so that the light may be mounted into the elbow extension that extends out of cap 22. The alternative inserts 13, 14 provide varied lengths for extending the elbow from the cap 22. In one particular embodiment of the present invention, the cap 22 and the elbow inserts 13, 14 are made of PVC piping, where the elbows snugly fit into the cap 22.

The magnetic base according to the present invention is very portable and used in different applications where additional light may be needed on a temporary basis. The magnetic light holder 10 helps to provide illumination in areas where a user has limited access to electrical power. Also the implementation of solar lighting provides an alternative energy source for the light. The magnetic light holder provides a means to mount this lighting onto metal surfaces in numerous outdoor situations beneficial to the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A magnetic holder for a lamp comprising:
a. a magnetic base, where magnetic base is capable of being mounted onto a metal surface; and
b. a hollow cylindrical device, where the cylindrical device provides a means for insertion of a solar-powered light and the cylindrical device is mounted on the base by an attachment means, where the cylindrical device extends above the top surface of the magnetic base.

2. The magnetic holder according to claim 1, where the attachment means includes a bolt.

3. The magnetic holder according to claim 2, where the means for insertion includes a cap.

4. The magnetic holder according to claim 1, where the base is mounted in either a horizontal or a vertical position.

5. The magnetic holder according to claim 3, where the cap receives a stem of the solar lamp.

6. The magnetic holder according to claim 3, where the cap receives an insert, where the insert includes a 90-degree elbow.
